(19) United States
(12) Patent Application Publication
(10) Pub. No.: US 2009/0281235 A1
(43) Pub. Date: Nov. 12, 2009

(54) Polystyrene compositions having improved mechanical properties and methods of using same

(76) Inventors: Theodore G. Harris, III, Houston, TX (US); Jon Tippet, League City, TX (US)

Correspondence Address: FINA TECHNOLOGY INC, PO BOX 674412, HOUSTON, TX, 77267-4412, US

(21) Appl. No.: 12/115,969

(22) Filed: May 6, 2008

(51) Int. Cl. C08L 25/06

(52) U.S. Cl. 524/577

(57) ABSTRACT

A polymeric composition comprising a styrenic polymer and a plasticizer, wherein the plasticizer comprises a polyisoalkylene and wherein the composition has a Vicat softening point of from 210° F. to 217° F. A method of increasing the impact strength of a styrenic polymer comprising contacting the styrenic polymer with an elastomer and a polyisoalkylene. A method of preparing a high impact polystyrene comprising introducing styrene monomer, an elastomer, polyisobutylene and mineral oil to a reaction zone under conditions suitable for the formation of a styrenic polymer.

### CROSS-REFERENCE TO RELATED APPLICATIONS

Not applicable.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

1. Technical Field

The present disclosure relates generally to the production of high-impact polystyrene and more specifically to the production of high-impact polystyrene having improved mechanical properties.

2. Background

Elastomer-reinforced polymers of monovinylidene aromatic compounds such as styrene, alpha-methylstyrene and ring-substituted styrene have found widespread commercial use. For example, elastomer-reinforced styrene polymers having discrete particles of cross-linked elastomer dispersed throughout the styrene polymer matrix can be useful for a range of applications including, but not limited to, food packaging, office supplies, point-of-purchase signs and displays, housewares and consumer goods, building insulation, and cosmetics packaging. Such elastomer-reinforced polymers are commonly referred to as high impact polystyrene (HIPS).

The utility of a particular HIPS depends on the polymer having some combination of mechanical, thermal, and physical properties that render the material suitable for a particular application. Oftentimes, additives are incorporated into a polymeric material to provide some beneficial properties that may range from improved mechanical properties (e.g., increased strength) to improved aesthetic qualities (e.g., increased gloss). However, there are often drawbacks associated with the use of these additives such that while a particular additive may beneficially affect a first set of one or more properties of the polymer; the same additive may simultaneously exert a detrimental effect on a second set of one or more polymer properties. For example, additives that improve the impact strength of a HIPS may adversely affect the thermal properties of the polymer. Thus, a need exists for a HIPS composition having improved impact strength while maintaining desired thermal properties.

### BRIEF SUMMARY

Disclosed herein is a polymeric composition comprising a styrenic polymer and a plasticizer, wherein the plasticizer comprises a polyisoalkylene and wherein the composition has a Vicat softening point of from 210° F. to 217° F.

Also disclosed herein is a method of increasing the impact strength of a styrenic polymer comprising contacting the styrenic polymer with an elastomer and a polyisoalkylene.

Further disclosed herein is a method of preparing a high impact polystyrene comprising introducing styrene monomer, an elastomer, polyisobutylene and mineral oil to a reaction zone under conditions suitable for the formation of a styrenic polymer.

### BRIEF DESCRIPTION OF THE DRAWINGS

For a more complete understanding of the present disclosure and the advantages thereof, reference is now made to the following brief description, taken in connection with the accompanying drawings and detailed description, wherein like reference numerals represent like parts.

FIG. 1 is a plot of the Izod impact strength as a function of the concentration of polyisobutylene for the samples from Example 1.

FIG. 2 is a plot of the Vicat softening temperature as a function of the concentration of polyisobutylene for the samples from Example 1.

FIG. 3 is a plot of the melt flow index as a function of the concentration of polyisobutylene for the samples from Example 1.

FIG. 4 is a plot of the Izod impact strength as a function of the polybutadiene concentration for the samples from Example 1.

### DETAILED DESCRIPTION

It should be understood at the outset that although an illustrative implementation of one or more embodiments are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

Disclosed herein are compositions comprising a polymer and a plasticizer-lubricant composition and methods of making and using same. In an embodiment, such compositions display improved mechanical properties such as an increased impact strength while maintaining user-desired thermal properties. Hereinafter such compositions are referred to as mechanically improved polystyrene compositions (MIPC).

In an embodiment, the MIPC comprises a styrenic polymer (e.g., polystyrene) wherein the styrenic polymer may be a homopolymer or may optionally comprise a polymer made from one or more comonomers. In an embodiment, one or more styrene monomers are used for the formation of the styrenic polymer as repeating units. Styrene, also known as vinyl benzene, cinnamene, ethyenylbenzene, and phenylethene is an organic compound represented by the chemical formula C₈H₈. Styrene is widely commercially available and as used herein the term styrene includes a variety of substituted styrenes (e.g., alpha-methyl styrene), ring-substituted styrenes such as p-methylstyrene, disubstituted styrenes such as p-t-butyl styrene as well as unsubstituted styrenes. In an embodiment, the styrenic polymer is present in an amount of from 1.0 weight percent (wt. %) to 99.9 wt. % by total weight of the MIPC, alternatively from 5 wt. % to 99 wt. %, and further alternatively from 10 wt. % to 95 wt. %. In an embodiment, the styrenic polymer comprises the balance of the MIPC when other ingredients are accounted for.

In some embodiments, the styrenic polymer may further comprise a comonomer which when polymerized with the styrene forms a styrenic copolymer. Examples of such comonomers may include for example and without limitation α-methylstyrene; halogenated styrenes; alkylated styrenes; acrylonitrile; esters of (meth)acrylic acid with alcohols having from 1 to 8 carbons; N-vinyl compounds such as vinylcarbazole, maleic anhydride; compounds which contain two polymerizable double bonds such as for example and without limitation divinylbenzene or butanediol diacrylate; or combinations thereof. The comonomer may be present in an amount effective to impart one or more user-desired properties to the composition. Such effective amounts may be determined by one of ordinary skill in the art with the aid of this disclosure. For example, the comonomer may be present in the styrenic polymer in an amount ranging from 1 wt. % to 99.9 wt. % by total weight of the MIPC, alternatively from 1 wt. % to 90 wt. %, alternatively from 1 wt. % to 50 wt. %.

In some embodiments, the styrenic polymer may further comprise an elastomer, and the resultant composition may be a high impact polystyrene (HIPS). Such HIPS contain an elastomeric phase that is embedded in the polystyrene matrix resulting in the composition having an increased impact resistance. In an embodiment, the styrenic polymer composition is a HIPS comprising a conjugated diene monomer as the elastomer. Examples of suitable conjugated diene monomers include without limitation 1,3-butadiene, 2-methyl-1,3-butadiene, 2-chloro-1,3 butadiene, 2-methyl-1,3-butadiene, and 2-chloro-1,3-butadiene. Alternatively, the HIPS comprises an aliphatic conjugated diene monomer as the elastomer. Without limitation, examples of suitable aliphatic conjugated diene monomers include C₄ to C₉ dienes such as butadiene monomers. Blends or copolymers of the diene monomers may also be used. Likewise, mixtures or blends of one or more elastomers may be used. In an embodiment, the elastomer comprises a homopolymer of a diene monomer, alternatively, the elastomer comprises polybutadiene.

In an embodiment, the MIPC comprises polybutadiene, alternatively a combination of high and medium-cis polybutadiene. Herein the designation cis refers to the stereoconfiguration of the individual butadiene monomers wherein the main polymer chain is on the same side of the carbon-carbon double bond contained in the polybutadiene backbone as is shown in Structure I.

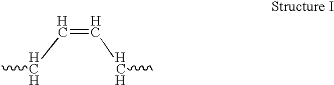

Herein medium-cis polybutadiene refers to a cis content of approximately 35%, alternatively from 6% to 99%, alternatively from 30% to 40%, while high-cis polybutadiene refers to a cis content of greater than approximately 90%, alternatively from 90% to 99%, wherein the cis content is measured by infrared spectroscopy or nuclear magnetic resonance. In an embodiment, an elastomer suitable for use in this disclosure comprises a mixture of high and medium cis polybutadiene wherein the medium cis polybutadiene is present in an amount of from 0 to 100%, alternatively from 20% to 80%, alternatively 50%; and the high cis polybutadiene is present in an amount of from 0 to 100%, alternatively from 20% to 80%, alternatively 50%.

Elastomers (e.g., polybutadiene) suitable for use in this disclosure may be further characterized by a low vinyl content. Herein a low vinyl content refers to a less than 5 wt. % of the material having terminal double bonds of the type represented in Structure II:

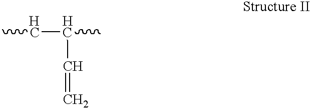

Such elastomers may be prepared by any suitable means for the preparation of a high and/or medium cis content elastomers (e.g., polybutadiene). For example, the elastomers may be prepared through a solution process using a transition metal or alkyl metal catalyst.

Examples of elastomers suitable for use in this disclosure include without limitation BUNA CB KA 8967 or 8969 butadiene elastomers, which are high cis polybutadiene elastomers commercially available from Lanxess Corporation or SE BR 1202D which is a high cis polybutadiene commercially available from Dow chemicals, and DIENE-55 (D-55) which is a medium cis polybutadiene elastomer further comprising IRGANOX 1076 and TNPP, which is commercially available from Firestone. In an embodiment, elastomers suitable for use in this disclosure include a mixture comprising a high-cis polybutadiene (e.g. DOW) and a medium cis polybutadiene (e.g., DIENE-55) which have generally the physical properties given in Tables 1 and 2, respectively.

TABLE 1

| | | | |
|---|---|---|---|
| PROPERTY | Min. | Max | Test Method |

Raw Polymer Properties

| | | | |
|---|---|---|---|
| Mooney Viscosity | 58 | 68 | DIN 53 523 |
| UML 1 + 4 (100° C.) (MU) | | | |
| Volatile matter (wt %) | | 0.5 | ASTM D 5668 |
| Total ash (wt %) | | 0.5 | ASTM D 5667 |
| Organic acid (5) | | 1.0 | ASTM D 5774 |

Cure Characteristics⁽¹⁾⁽²⁾

| Minimum torque (dN, m) | 4.3 | 6.3 | ISO 6502 |
|---|---|---|---|
| Maximum Torque, S′ max. | 19.9 | 25.3 | ISO 6502 |
| (dN, m) | | | |
| tₛ1 (min) | 2.1 | 3.1 | ISO 6502 |
| t′50 (min) | 6.6 | 9.8 | ISO 6502 |
| Other Product Features | | Typical Value | |
| Cis 1,4-content | | 96 | |
| Specific Gravity | | 0.91 | |
| Stabilizer Type | | Non-staining | |

⁽¹⁾Monsanto Rheometer, MDR at 160° C., 30 min., ±0.5 degree arc
⁽²⁾Cure characteristics determined on formulation according to ISO 2476

TABLE 2

| | | | |
|---|---|---|---|
| PROPERTY | Min. | Max | Test Method |

Raw Polymer Properties

| | | | |
|---|---|---|---|
| Mooney Viscosity | 39 | 49 | DIN 53 523 |
| UML 1 + 4 (100° C.) (MU) | | | |
| Volatile matter (wt %) | | 0.5 | ASTM D 5668 |
| Total ash (wt %) | | 0.5 | ASTM D 5667 |
| Organic acid (5) | | 1.0 | ASTM D 5774 |

Cure Characteristics⁽¹⁾⁽²⁾

| Minimum torque (dN, m) | 2.3 | 3.3 | ISO 6502 |
|---|---|---|---|
| Maximum Torque, S′ max. | 16.7 | 21.3 | ISO 6502 |
| (dN, m) | | | |
| tₛ1 (min) | 2.2 | 3.2 | ISO 6502 |
| t′50 (min) | 5.9 | 8.7 | ISO 6502 |
| Other Product Features | | Typical Value | |
| Cis 1,4-content | | 96 | |
| Specific Gravity | | 0.91 | |
| Stabilizer Type | | Non-staining | |

⁽¹⁾Monsanto Rheometer, MDR at 160° C., 30 min., ±0.5 degree arc
⁽²⁾Cure characteristics determined on formulation according to ISO 2476

The elastomer may be present in amounts effective to produce one or more user-desired properties. Such effective amounts may be determined by one of ordinary skill in the art with the aid of this disclosure. For example, the elastomer may be present in the MIPC in an amount ranging from 0.1 wt. % to 50 wt. % by total weight of the composition, alternatively from 0.5 wt. % to 40 wt. %, alternatively from 1 wt. % to 30 wt. %. In an embodiment, the MIPC comprises a mixture of elastomers, for example a mixture of high cis and medium cis polybutadiene elastomers. In such embodiments, the ratio of high cis: medium cis polybutadiene present in the MIPC may be 10:1; alternatively 1:10, alternatively 1:1.

In an embodiment, the MIPC comprises a plasticizer, a lubricant, or combinations thereof. Herein a plasticizer refers to an additive that softens the materials they are added to resulting in a final product having an increased flexibility. Herein a lubricant refers to a substance introduced between two contacting surfaces to reduce the friction and wear between them. In an embodiment, the plasticizer and lubricant is the same compound. Examples of compounds that can serve as both plasticizers and lubricants in the compositions disclosed herein include without limitation mineral oil, polyisobutylene, plant derived oils, phthalates, siloxanes, or combinations thereof. Such dual functionality compounds are hereinafter referred to as plasticizer-lubricant compounds. In an embodiment, the plasticizer-lubricant compound comprises any material that is liquid at room temperature and able to function as a plasticizer-lubricant compound. In some embodiments, the plasticizer-lubricant compound comprises an alpha-olefin; a polybutadiene for example a linear, low viscosity polybutadiene; a polyisoalkylene; or combinations thereof. In an embodiment, the plasticizer-lubricant compound comprises a polyisoalkylene; alternatively polyisobutylene (PIB).

The MIPC may comprise more than one plasticizer-lubricant compound and such compositions containing more than one plasticizer-lubricant compound are hereinafter referred to as plasticizer-lubricant mixtures (PLM). For example, the PLM may comprise mineral oil and PIB. The amount of PIB may be effective to impart one or more user-desired properties to the polymer composition. In an embodiment, the PLM comprises mineral oil and PIB wherein the mineral oil is present in an amount of from 0.5 wt % to 10 wt. %; alternatively from 0.5 wt. % to 3.5 wt. %; and further alternatively from 0.5 wt. % to 1 wt. % by weight of the MIPC, and the PIB is present in an amount of from 0.5 wt. % to 10 wt. %; alternatively from 0.5 wt. % to 3.5 wt. %; and further alternatively from 0.5 wt. % to 2.5 wt. % by weight of the MIPC. In an embodiment, the ratio of mineral oil to PIB in the PLM is from 1 to 10, alternatively from 1 to 2.5, alternatively from 1 to 1. The PLM may be present in the MIPC in an amount of from 1 wt. % to 10 wt. % by weight of the MIPC, alternatively from 1 wt. % to 5 wt. %, and further alternatively from 1 wt. % to 3.5 wt. %. Hereinafter, the disclosure will focus on the use of a PLM comprising PIB and mineral oil as the plasticizer-lubricant compounds although other plasticizer-lubricant compounds of the type disclosed herein are also contemplated.

In an embodiment, a method for the production of an MIPC comprises the dissolution of polybutadiene elastomer (e.g., a mixture of medium and high cis PB) in styrene that is subsequently polymerized. During polymerization, a phase separation based on the immiscibility of polystyrene (PS) and polybutadiene (PB) occurs in two stages. Initially, the PB forms the major or continuous phase with styrene dispersed therein. As the reaction progresses and the amount of polystyrene continues to increase, a morphological transformation or phase inversion occurs such that the PS now forms the continuous phase and the PB and styrene monomer forms the discontinuous phase. This phase inversion leads to the formation of the discontinuous phase comprising complex elastomeric particles in which the elastomer exists in the form of PB membranes surrounding occluded domains of PS. The polymerization may be represented according to the chemical equations given below:

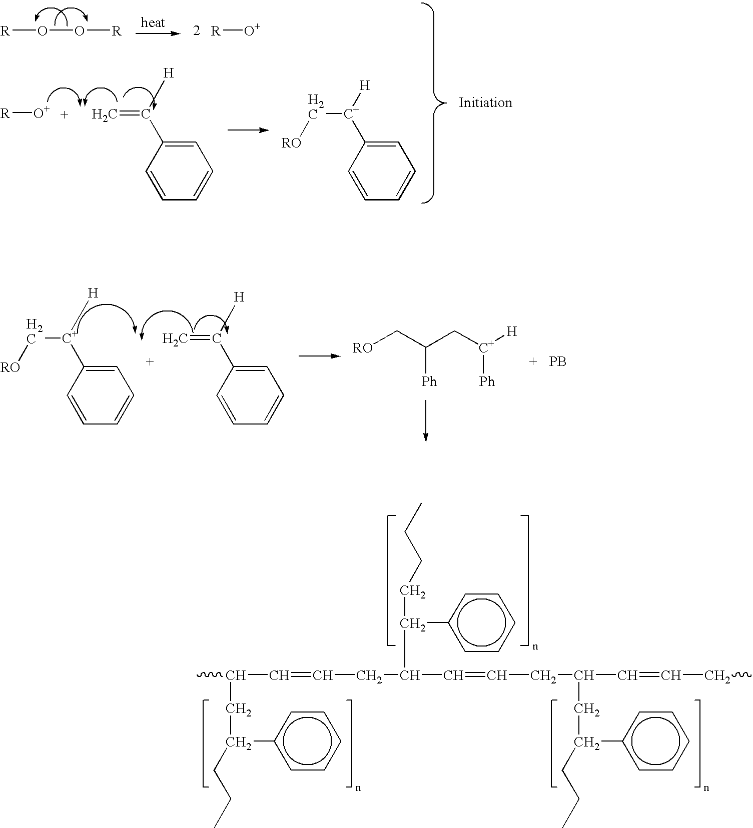

In an embodiment, the MIPC production process employs at least one polymerization initiator. Such initiators may function as a source of free radicals to enable the polymerization of styrene. In an embodiment, any initiator capable of free radical formation that facilitates the polymerization of styrene may be employed. Such initiators include by way of example and without limitation organic peroxides. Examples of organic peroxides useful for polymerization initiation include without limitation diacyl peroxides, peroxydicarbonates, monoperoxycarbonates, peroxyketals, peroxyesters, dialkyl peroxides, hydroperoxides or combinations thereof. In an embodiment, the initiator level in the reaction is given in terms of the active oxygen in parts per million (ppm). In an embodiment, the level of active oxygen level in the disclosed reactions for the production of the MIPC is from 20 ppm to 80 ppm, alternatively from 20 ppm to 60 ppm, and further alternatively from 30 ppm to 60 ppm. The selection of initiator and effective amount will depend on numerous factors (e.g., temperature, reaction time) and can be chosen by one skilled in the art with the aid of this disclosure to meet the desired needs of the process. Polymerization initiators and their effective amounts have been described, for example, in U.S. Pat. Nos. 6,822,046; 4,861,127; 5,559,162; 4,433,099; and 7,179,873, each of which is incorporated by reference herein in its entirety.

In an embodiment, a method for production of the MIPC comprises contacting styrene monomer and other components (e.g., mixture of medium and high cis elastomer) under reaction conditions suitable for the polymerization of the monomer. The plasticizer/lubricant or PLM (e.g., PIB and mineral oil) may be added at anytime before recovery (e.g., pelletization) of the MIPC. For example, the plasticizer/lubricant may be added through independent feedlines and mixed in situ in a polymerization reactor, alternatively the plasticizer/lubricant may be combined with the other components of the reaction mixture and subsequently introduced to the reaction zone.

The polymerization reaction to form the MIPC may be carried out in a solution or mass polymerization process. Mass polymerization, also known as bulk polymerization refers to the polymerization of a monomer in the absence of any medium other than the monomer and a catalyst or polymerization initiator. Solution polymerization refers to a polymerization process in which the monomers and polymerization initiators are dissolved in a non-monomeric liquid solvent at the beginning of the polymerization reaction. The liquid is usually also a solvent for the resulting polymer or copolymer.

The polymerization process can be either batch or continuous. In an embodiment, the polymerization reaction may be carried out using a continuous production process in a polymerization apparatus comprising a single reactor or a plurality of reactors. For example, the polymeric composition can be prepared using an upflow reactor. Reactors and conditions for the production of a polymeric composition are disclosed, for example, in U.S. Pat. No. 4,777,210, which is incorporated by reference herein in its entirety.

The temperature ranges useful with the process of the present disclosure can be selected to be consistent with the operational characteristics of the equipment used to perform the polymerization. In one embodiment, the temperature range for the polymerization can be from 90° C. to 240° C. In another embodiment, the temperature range for the polymerization can be from 100° C. to 180° C. In yet another embodiment, the polymerization reaction may be carried out in a plurality of reactors with each reactor having an optimum temperature range. For example, the polymerization reaction may be carried out in a reactor system employing a first and second polymerization reactors that are either continuously stirred tank reactors (CSTR) or plug-flow reactors. In an embodiment, a polymerization reactor for the production of an MIPC of the type disclosed herein comprising a plurality of reactors may have the first reactor (e.g., a CSTR), also known as the prepolymerization reactor, operated in the temperature range of from 90° C. to 135° C. while the second reactor (e.g., CSTR or plug flow) may be operated in the range of from 100° C. to 165° C.

The polymerized product effluent from the first reactor may be referred to herein as the prepolymer. When the prepolymer reaches the desired conversion, it may be passed through a heating device into a second reactor for further polymerization. The polymerized product effluent from the second reactor may be further processed as described in detail in the literature. Upon completion of the polymerization reaction, an MIPC is recovered and subsequently processed, for example devolatized, pelletized, etc.

In an embodiment, the MIPC may also comprise additives as deemed necessary to impart desired physical properties, such as, increased gloss or color. Examples of additives include without limitation chain transfer agents, talc, antioxidants, UV stabilizers, and the like. The aforementioned additives may be used either singularly or in combination to form various formulations of the composition. For example, stabilizers or stabilization agents may be employed to help protect the polymeric composition from degradation due to exposure to excessive temperatures and/or ultraviolet light. These additives may be included in amounts effective to impart the desired properties. Effective additive amounts and processes for inclusion of these additives to polymeric compositions are known to one skilled in the art with the aid of this disclosure. For example, one or more additives may be added after recovery of the MIPC, for example during compounding such as pelletization. Alternatively or additionally to the inclusion of such additives in the styrenic polymer component of the MIPCs, such additives may be added during formation of the MIPCS or to one or more other components of the MIPCs.

The MIPC and end-use articles constructed therefrom may display improved impact strength as determined by an increase in the Izod impact strength. Izod impact is defined as the kinetic energy needed to initiate a fracture in a specimen and continue the fracture until the specimen is broken. Tests of the Izod impact strength determine the resistance of a polymer sample to breakage by flexural shock as indicated by the energy expended from a pendulum type hammer in breaking a standard specimen in a single blow. The specimen is notched which serves to concentrate the stress and promotes a brittle rather than ductile fracture. Specifically, the Izod Impact test measures the amount of energy lost by the pendulum during the breakage of the test specimen. The energy lost by the pendulum is the sum of the energies required to initiate sample fracture, to propagate the fracture across the specimen, and any other energy loss associated with the measurement system (e.g., friction in the pendulum bearing, pendulum arm vibration, sample toss energy). In an embodiment, the MIPC and end-use articles constructed therefrom have an Izod impact strength of from 1.0 ft.lb/inch to 5.0 ft.lb/inch, alternatively from 3.0 ft.lb/inch to 4.5 ft.lb/inch as determined in accordance with ASTM D-256A. The Izod impact strength of the MIPC and end-use articles prepared therefrom may be increased by an amount of equal to or greater than 15%, alternatively equal to or greater than 20%, alternatively equal to or greater than 25% when compared to an otherwise similar composition prepared in the absence of PIB.

Inclusion of PIB in the MIPC may result in minimal changes in the Vicat softening temperature of the MIPC. The Vicat softening temperature refers to the softening temperature for a plastic material. It is taken as the temperature at which a specimen is penetrated to a depth of 1 mm by a flat-ended needle with a 1 sq. mm circular or square cross section. In an embodiment, the MIPCs of this disclosure have a Vicat softening temperature of from 210° F. to 217° F., alternatively of from 212° F. to 214° F., alternatively of from 213° F. to 215° F.

In an embodiment, the inclusion of PIB as a component of the PLM may result in minimal changes in the melt flow rate (MFR) (also termed the melt flow index) of the MIPC. In an embodiment, the MIPC may have a MFR of from 1.5 g/10 min. to 20 g/10 min., alternatively from 2.0 g/10 min. to 3.5 g/10 min., alternatively from 2.4 g/10 min. to 3.2 g/10 min. Excellent flow properties as indicated by a high MFR allow for high throughput manufacturing of molded polymeric components. The MFR may be determined using a dead-weight piston plastometer that extrudes polystyrene through an orifice of specified dimensions at a temperature of 200° C. and a load of 5 kg as determined in accordance with ASTM Standard Test Method D-1238.

In an embodiment, an MIPC prepared as described herein may have a Gardner impact of from 6 in-lb to 180 in-lb, alternatively from 110 in-lb to 180 in-lb, and further alternatively from 150 in-lb to 170 in-lb as determined in accordance with ASTM D3029; a tensile modulus of from 230,000 psi to 370,000 psi, alternatively from 250,000 psi to 320,000 psi, and further alternatively from 280,000 psi to 320,000 psi as determined in accordance with ASTM D638; a tensile strength at yield of from 2,500 psi to 7,500 psi, alternatively from 2,500 psi to 4,000 psi, and further alternatively from 3,600 psi to 4,000 psi as determined in accordance with ASTM D882; an elongation at yield of from 5% to 70%, alternatively from 45% to 60%, and further alternatively from 45% to 55% as determined in accordance with ASTM D882; a tensile strength at break of from 2,500 psi to 7,500 psi, alternatively from 2,500 psi to 4,000 psi, and further alternatively from 3,600 psi to 4,000 psi as determined in accordance with ASTM D638; a flexural modulus of from 240,000 psi to 430,000 psi, alternatively from 260,000 psi to 370,000 psi, and further alternatively of from 280,000 psi to 320,000 psi as determined in accordance with ASTM D790; and an annealed heat distortion of from 189° F. to 209° F., alternatively from 193° F. to 206° F., and further alternatively from 199° F. to 200° F. as determined in accordance with ASTM D648.

The MIPCs of this disclosure may be converted to end-use articles by any suitable method. The end use articles may be produced concurrently with the mixing and/or forming of the MIPCs (e.g., on a sequential, integrated process line) or may be produced subsequent to mixing and/or forming of the MIPCs (e.g., on a separate process line such as an end use compounding and/or thermoforming line). Examples of end-use articles into which the MIPCs may be formed include food packaging; office supplies; custom sheet for thermoforming; food service items such as cups, plates, bowls, daily containers; and so forth. Additional end use articles would be apparent to those skilled in the art with the aid of this disclosure.

### EXAMPLES

The embodiments having been generally described, the following examples are given as particular embodiments of the disclosure and to demonstrate the practice and advantages thereof. It is understood that the examples are given by way of illustration and are not intended to limit the specification or the claims in any manner.

### Example 1

The effect of the use of PIB in a plasticizer-lubricant mixture on the mechanical and thermal properties of a HIPS composition was investigated. Feed solutions comprising styrene monomer, DIENE-55 elastomer, and DOW 1202 elastomer were mixed in a dissolving tank in the amounts indicated in Table 3 and polymerized to form a HIPS. The amounts are given as weight percentages of the total composition, and styrene monomer constitutes the majority of the remaining amount of the compositions. Mineral oil and PIB were added to the composition in the dissolving tank in the amounts indicated in Table 3. The total concentrations of elastomer, plasticizer, the percentage of plasticizer/lubricant that comprised the PIB, and the percentage of high cis polybutadiene in the HIPS for each sample from Table 3 are given in Table 4. Values for the melt flow index, the Izod impact strength, and the Vicat softening temperature for the sample compositions as determined in accordance with ASTM D 1238 G, D 256, and D 1525 respectively are presented in Table 5.

TABLE 3

| | Sample | | | | | | | |
|---|---|---|---|---|---|---|---|---|
| Reagent | C | 1 | 2 | 3 | 4 | 5 | 6 | 7 |
| Medium cis: DIENE-55 | 3.88 | 3.88 | 4.05 | 3.99 | 9.47 | 0.00 | 2.77 | 1.83 |
| High cis: DOW 1202 | 3.88 | 3.88 | 4.05 | 3.99 | 0.00 | 7.85 | 2.77 | 1.83 |
| Mineral Oil | 1.23 | 0.00 | 1.78 | 3.51 | 1.00 | 0.98 | 0.93 | 0.92 |
| PIB | 3.05 | 4.29 | 1.78 | 0.00 | 2.51 | 2.46 | 2.32 | 2.29 |

C = control

TABLE 4

| | Sample | | | | | | | |
|---|---|---|---|---|---|---|---|---|
| Total Amount of Reagent | C | 1 | 2 | 3 | 4 | 5 | 6 | 7 |
| Elastomer | 7.8 | 7.8 | 8.1 | 8.0 | 9.5 | 7.9 | 5.5 | 3.7 |
| Plasticizer | 4.3 | 4.3 | 3.6 | 3.5 | 3.5 | 3.4 | 3.2 | 3.2 |
| % PIB of total plasticizer | 71.3 | 100 | 50 | 0 | 71.4 | 71.4 | 71.4 | 71.4 |
| % high cis elastomer in polymer | 50 | 50 | 50 | 50 | 0 | 100 | 50 | 50 |
| % medium cis in polymer | 50 | 50 | 50 | 50 | 100 | 0 | 50 | 50 |

TABLE 5

| | Sample | | | | | | | |
|---|---|---|---|---|---|---|---|---|
| Property | C | 1 | 2 | 3 | 4 | 5 | 6 | 7 |
| MFI (g/10 min.) | 1.34 | 1.15 | 1.47 | 1.78 | 1.07 | 1.40 | 1.67 | 2.27 |
| Izod Impact (ft.lbs/in) | 3.84 | 3.88 | 3.82 | 3.23 | 3.67 | 4.36 | 2.52 | 1.06 |
| Vicat Softening Temperature (° F.) | 214 | 217 | 214 | 210 | 215 | 216 | 214 | 215 |

Samples 1 to 7 had formulations that varied in the amount of elastomer and plasticizer which were compared to a base formulation comprising PIB and mineral oil. The results demonstrate the inclusion of PIB into the HIPS resulted in an increased Izod impact with minimal effect on the Vicat softening temperature. In addition, as the amount of PIB in the sample increased, the melt flow was observed to decrease.

### Example 2

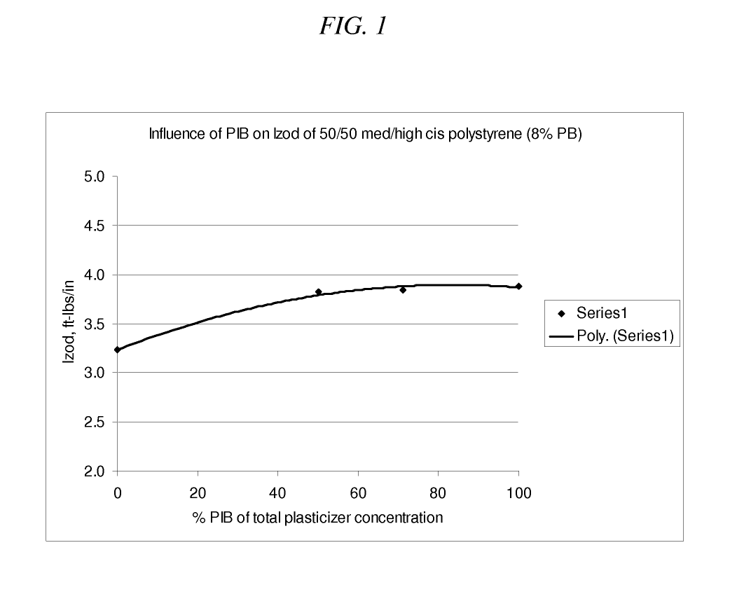

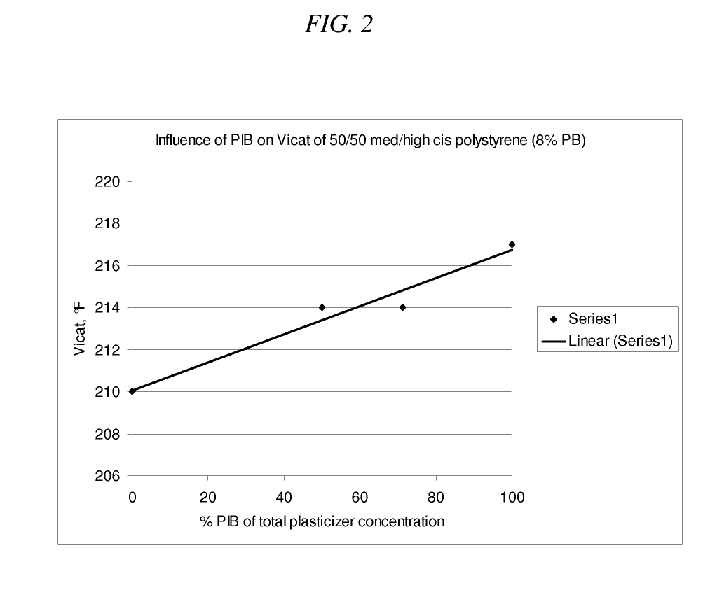

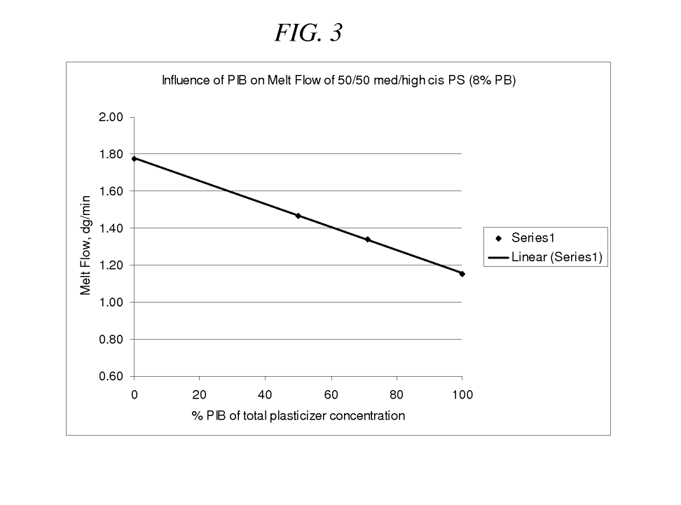

The effect of the PIB concentration on the Izod impact strength and Vicat softening temperature of a HIPS was investigated. Specifically, HIPS samples comprising 50% high-cis polybutadiene, 50% medium cis polybutadiene and the indicated amounts of PIB were prepared. The Izod impact strength and Vicat softening temperatures for each sample was determined as described previously and plots of the Izod impact strength as a function of PIB concentration, the Vicat softening temperature as a function of PIB concentration, the MFI as a function of PIB concentrations are shown in FIGS. 1, 2, and 3 respectively. The results demonstrate that as the PIB concentration increased the Izod impact strength of the HIPS increased while the Vicat softening temperature remained similar over the concentration of PIB investigated.

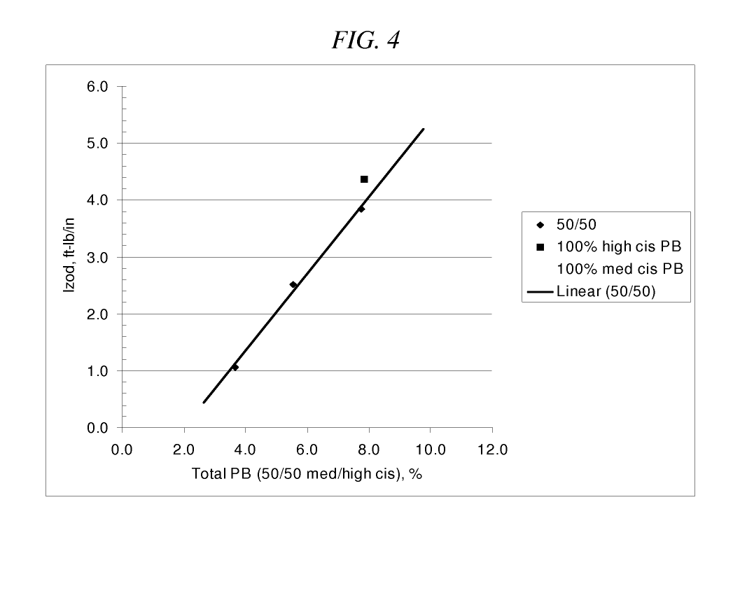

The effect of the percentage polybutadiene in a polymer on the Izod impact strength was also investigated and this is shown in FIG. 4. HIPS samples comprising either 100% high-cis polybutadiene, 100% medium cis polybutadiene, or a 50/50 med/high-cis polybutadiene mixture at concentrations of and about 4 wt. %, about 6 wt. % and about 8 wt. % were prepared. Herein, the concentration of polybutadiene in the polymer was assumed to be the same as the concentration of polybutadiene in the feed. FIG. 4 is a plot of the Izod impact strength as a function of the total polybutadiene concentration. The Izod impact strength increased with increasing PB concentrations.

While various embodiments have been shown and described, modifications thereof can be made by one skilled in the art without departing from the spirit and teachings of the disclosure. The embodiments described herein are exemplary only, and are not intended to be limiting. Many variations and modifications of the subject matter disclosed herein are possible and are within the scope of the disclosure. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). For example, whenever a numerical range with a lower limit, R_{L}, and an upper limit, R_{U}, is disclosed, any number falling within the range is specifically disclosed. In particular, the following numbers within the range are specifically disclosed: R=R_{L}+k*(R_{U}−R_{L}), wherein k is a variable ranging from 1 percent to 100 percent with a 1 percent increment, i.e., k is 1 percent, 2 percent, 3 percent, 4 percent, 5 percent, . . . 50 percent, 51 percent, 52 percent, . . . , 95 percent, 96 percent, 97 percent, 98 percent, 99 percent, or 100 percent. Moreover, any numerical range defined by two R numbers as defined in the above is also specifically disclosed. Use of the term “optionally” with respect to any element of a claim is intended to mean that the subject element is required, or alternatively, is not required. Both alternatives are intended to be within the scope of the claim. Use of broader terms such as comprises, includes, having, etc. should be understood to provide support for narrower terms such as consisting of, consisting essentially of, comprised substantially of, etc.

Accordingly, the scope of protection is not limited by the description set out above but is only limited by the claims which follow, that scope including all equivalents of the subject matter of the claims. Each and every claim is incorporated into the specification as an embodiment of the present disclosure. Thus, the claims are a further description and are an addition to the embodiments of the present disclosure. The discussion of a reference is not an admission that it is prior art to the present disclosure, especially any reference that may have a publication date after the priority date of this application. The disclosures of all patents, patent applications, and publications cited herein are hereby incorporated by reference, to the extent that they provide exemplary, procedural, or other details supplementary to those set forth herein.

What is claimed is:

1. A polymeric composition comprising a styrenic polymer and a plasticizer, wherein the plasticizer comprises a polyisoalkylene and wherein the composition has a Vicat softening point of from 210° F. to 217° F.

2. The composition of claim 1 wherein the polyisoalkylene comprises polyisobutylene.

3. The composition of claim 2 wherein the polyisobutylene is present in an amount of from 0.5 wt. % to 10 wt. % based on the total weight of the polymeric composition.

4. The composition of claim 1 wherein the plasticizer further comprises mineral oil.

5. The composition of claim 4 wherein the mineral oil is present in an amount of from 0.5 wt. % to 10 wt. % based on the total weight of the polymeric composition.

6. The composition of claim 4 wherein the polyisoalkylene comprises polyisobutylene and wherein the ratio of polyisobutylene to mineral oil is from 10 to 1.

7. The composition of claim 1 wherein the styrenic polymer comprises polystyrene.

8. The composition of claim 7 wherein the polystyrene further comprises an elastomer.

9. The composition of claim 8 wherein the elastomer comprises a high-cis polybutadiene, a medium cis polybutadiene, or combinations thereof.

10. The composition of claim 9 wherein the ratio of high cis: medium cis polybutadiene is from 0:100 to 100:0.

11. The composition of claim 8 wherein the elastomer has a vinyl content of less than 5%.

12. The composition of claim 8 wherein the elastomer is present in an amount of from 0.1 wt. % to 50 wt. % based on the total weight of the polymeric composition.

13. The composition of claim 1 having an Izod impact strength of from 1.0 ft.lb/inch to 5.0 ft.lb/inch.

14. The composition of claim 1 having a melt flow index of from 1.5 g/10 min. to 20 g/10 min.

15. An article comprised of the polymeric composition of claim 1.

16. The article of claim 15 is a container for food packaging, office supplies, sheets for thermoforming, food service items, cups, plates, bowls, daily containers, or combinations thereof.

17. A method of increasing the impact strength of a styrenic polymer comprising contacting the styrenic polymer with an elastomer and a polyisoalkylene.

18. The method of claim 17 wherein the elastomer comprises a mixture of high cis and medium cis conjugated dienes.

19. The method of claim 17 wherein the polyisoalkylene comprises polyisobutylene.

20. The method of claim 17 wherein the Izod impact strength of the styrenic polymer is from 1.0 ft.lb/inch to 5.0 ft.lb/inch.

21. A method of preparing a high impact polystyrene comprising:
introducing styrene monomer, an elastomer, polyisobutylene and mineral oil to a reaction zone under conditions suitable for the formation of a styrenic polymer.

22. The method of claim 21 wherein, the styrene monomer is present in an amount of from 1.0 wt. % to 99.9 wt. %;
polyisobutylene is present in an amount of from 0.5 wt. % to 10 wt. %;
mineral oil is present in an amount of from 0.5 wt. % to 1.0 wt. %; and
wherein the elastomer comprises polybutadiene which is present in an amount of from 0.1 wt. % to 50 wt. %.

23. The method of claim 22 wherein the polyisobutylene, styrene, elastomer, and mineral oil are contacted with each other to form a mixture prior to introduction of the components to the reaction zone.
